(19) United States
(12) Patent Application Publication
(10) Pub. No.: US 2024/0042827 A1
(43) Pub. Date: Feb. 8, 2024

(54) PORTABLE COOLING DEVICE AND SYSTEM FOR AN OPEN AIR VEHICLE

(71) Applicant: Air Innovations, Inc., North Syracuse, NY (US)

(72) Inventors: Marcos Locke, Baldwinsville, NY (US); Michael Wetzel, Skaneateles, NY (US)

(73) Assignee: Air Innovations, Inc., North Syracuse, NY (US)

(21) Appl. No.: 18/230,362

(22) Filed: Aug. 4, 2023

Related U.S. Application Data
(60) Provisional application No. 63/395,467, filed on Aug. 5, 2022.

(51) Int. Cl. B60H 1/00; B60H 1/32

(52) U.S. Cl. CPC B60H 1/00871; B60H 1/3202

(57) ABSTRACT

A portable cooling device for an open air vehicle includes a housing structured to be installed behind an operator. The housing includes a front surface, a rear surface and right and left side surfaces. One or more intakes are positioned on at least of the left and right side surfaces and are structured to enable intake of outside air. One or more exhaust vents are positioned on the rear surface to exhaust heat from the housing. One or more cooling vents are positioned on the front surface. The portable cooling device includes one or more diverters coupled to each cooling vent and structured to convey cooled air from the one or more cooling vents to an area proximate to a head or neck of the operator of the open air vehicle. The housing width is less than about 30 inches and the housing depth is less than about 12 inches.

### CROSS-REFERENCE TO RELATED APPLICATION

This application is a Non-Provisional Patent Application of, and claiming the benefit and priority of Provisional Patent Application No. 63/395,467 filed on Aug. 5, 2022. The entire contents of said application are hereby incorporated by reference.

### TECHNICAL FIELD

This disclosure relates to a cooling device for an open air vehicle and more specifically, a cooling device that is mounted within the confines of the open-air vehicle and structured to draw in ambient air from the surrounding environment, cool the ambient air to a temperature at least 10 degrees below ambient temperature, and deliver the cooled air to specific areas of an operator of the open air vehicle.

### BACKGROUND

Open air vehicles, such as fork-lifts, golf carts, and construction vehicles are used for a variety of jobs in a variety of environments. For example, forklifls are used to transport pallets of goods within warehouses as well as to and from semi-trailer trucks and/or shipping containers. In another example, bulldozers are used outdoors to move material or otherwise sculpt the grade of a piece of property. In yet another example, a golf cart is used to transport golfers and their gear along the golf course during a round of golf as well for general transport of individuals and goods. These are just a few examples of open air vehicles and their possible uses.

A common theme among open air vehicles is that their driving areas, cages or cabs are open to the surrounding environment. Consequently, the operators are exposed to temperatures of the external environment. On hot days or in un air-conditioned warehouses, this means that the operators are exposed to the hot air temperatures for the duration of their shifts. As with any job, a comfortable work environment generally leads to increased productivity by employees. When an operator is exposed to hot temperatures over a prolonged period of time, they are uncomfortable at the very least and sometimes may become ill from overexposure. This all leads to decreased productivity and an increased probability of mistakes or accidents. Keeping the operator/occupants of open air vehicles cool and comfortable presents many challenges.

Traditionally, simple fans have been used to blow ambient air from the outside environment at the driver/occupants. On hot days, this method is inadequate to cool the operator/occupants. Furthermore, a continuous flow of air into one's face tends to dry out the eyes, which increases operator discomfort. Another solution to this problem has been to mount a cooling unit on top of the driver area, cage or cab of the open air vehicle. However, this solution alters the dimensions of the open air vehicle. In the case of a forklift, for example, it is specifically dimensioned to enter into shipping containers and semi-trailers. Altering the dimensions of the forklift would negatively impact the ability of the vehicle to perform its intended job. Moreover, many of the open air vehicles are exposed to collisions or other exterior trauma as a result of the work they are required to do and the conditions under which they are used. Positioning the cooling unit outside the cage exposes the cooling unit to damage as it is not build to withstand these collisions/trauma.

Yet another solution is to retro-fit an enclosed cab onto the open air vehicle so that the enclosed cab can be cooled in the normal fashion. This is a very expensive solution and may further change the dimensions of the open air vehicle. Still another solution has been to mount a cooling unit inside the driver area in a position directly above the driver. However, this solution presents a risk for head injury for the driver in the best case and in the worst case prevents taller drivers from even being able to physically fit inside the vehicle. Split cooling units have been used that are mounted above the driver and to either side of the driver. Again, this is dangerous since these split units act to obstruct the driver's view to either side thereby increasing the risk of a collision.

These are just some of the problems associated with the current solutions used to cool operators/occupants of open air vehicles.

### SUMMARY

The disclosed portable cooling device for open air vehicles has many advantages over currently used cooling devices. The disclosed portable cooling device is a self-contained and compact unit that is dimensioned to be installed behind the driver/operator of the open air vehicle without increasing the overall size dimensions of the open air vehicle. The portable cooling device may be easily installed onto the open air vehicle and uninstalled from the open air vehicle. The portable cooling device may have its own power source, such as a rechargeable battery or may be electrically coupled to the battery of the open air vehicle. The low power draw makes the discloses portable cooling device very energy efficient such that it will not impede the performance of the open air vehicle when connected to a shared power source. As previously mentioned, the portable cooling device is dimensioned to be installed behind the driver/operator of the open air vehicle. In this manner, the operator's forward and side view is not obstructed. Moreover, the cooling vents of the portable cooling device are structured to deliver cooled air to the back/sides of the neck and head area, which inhibits drying of the operator's eyes caused by a continuous flow of air at the operator's face. Furthermore, the back/sides of the head and neck area are dense with blood vessels that are close to the skin surface. Therefore, cooling these areas results in a better, faster and more efficient cooling of the operator than simply blowing air into the operator's face. The cooling vents are further structured to minimize the distance that the cooled air must travel between the portable cooling device and the back/side of the head/neck of the operator. This further improves the efficiency and electiveness of the portable cooling device as more cooled air reaches the target and is not lost to the surrounding open environment.

An embodiment of a portable cooling device for an open air vehicle includes a housing structured to be installed behind an operator of the open air vehicle. The housing includes a front surface, an opposing rear surface and right and left side surfaces. One or more intakes are positioned on at least of the left and right side surfaces of the housing and are structured to enable intake of ambient air surrounding an outside of the housing. One or more exhaust vents are positioned on the rear surface of the housing and are structured to enable heat from inside the housing to dissipate to an outside of the housing. One or more cooling vents are positioned on the front surface of the housing. The housing surrounds a condenser, an evaporator, and one or more fans. The one or more fans draw ambient air through the one or more intakes, move the ambient air though the evaporator and condenser, and expel cooled air from the one or more cooling vents. The portable cooling device further includes one or more diverters coupled to each of the one or more cooling vents and structured to convey the cooled air from the one or more cooling vents to an area proximate to a head or neck of the operator of the open air vehicle. The housing has a housing width that is defined as a dimension from the right side to the left side. The housing has a housing depth that is defined as a dimension from the front surface to the opposing rear surface. The housing width is less than about 30 inches and the housing depth is less than about 12 inches.

In an embodiment, the housing further includes a top surface and a bottom surface, wherein a height is defined as a dimension from the top surface to the bottom surface and is less than about 9 inches. In an embodiment, the area proximate to the head or neck of the operator is about 12 inches from the head or neck of the operator. In an embodiment, the portable cooling device is further structured to cool the ambient air drawn in by the one or more intakes to a temperature at least 10° cooler than the ambient air. In an embodiment, the one or more diverters are flexible and are positioned to be on either side of the operator when installed in the open air vehicle. In another embodiment, the one or more diverters are structured to automatically adjust according to changes in operator's body position. In a further embodiment, the portable cooling device requires not more than about 600 W of power to operate.

An embodiment of a portable cooling system for an open air vehicle includes a portable cooling device and a mounting assembly structured to couple to the open air vehicle and support the portable cooling apparatus. In an embodiment, the mounting assembly is structured to mount to the open air vehicle in a location behind the operator. In an embodiment, the mounting assembly includes one or more clamps or brackets structured to engage a frame of an open air vehicle, a mounting frame structured to support the housing, and one or more vibration damping elements coupled to the mounting frame and structured to lessen vibrations imparted to the open air vehicle by the housing. In an embodiment, the mounting assembly further includes an actuator structured to move one or more components of the mounting assembly relative to the frame of the open air vehicle.

### BRIEF DESCRIPTION OF THE DRAWINGS

A more particular description of the invention briefly summarized above may be had by reference to the embodiments, some of which are illustrated in the accompanying drawings. It is to be noted, however, that the appended drawings illustrate only typical embodiments of this invention and are therefore not to be considered limiting of its scope, for the invention may admit to other equally effective embodiments. Thus, for further understanding of the nature and objects of the invention, references can be made to the following detailed description, read in connection with the drawings.

FIG. 1 illustrates a right side perspective view of an embodiment of a cooling device mounted to an open air vehicle with a plurality of vents that direct cool air down to the neck/head area of the operator.

FIG. 2 illustrates a right side perspective view of an embodiment of a cooling device mounted to an open air vehicle with a plurality of vents that direct cool air up to the neck/head area of the operator of FIG. 1.

FIG. 3 illustrates a left side perspective view of the embodiment of a cooling device of FIG. 1.

FIG. 4 illustrates a rear perspective view of the embodiment of FIG. 2.

FIG. 5 illustrates another rear perspective view of the embodiment of FIG. 2.

FIG. 6A illustrates a top perspective view of the embodiment of FIG. 2.

FIG. 6B illustrates a front perspective view of an embodiment of a cooling device with diverters.

FIG. 7 illustrates a close-up front, perspective view of the cooling device of FIG. 2.

FIG. 8 illustrates a close-up view of the embodiment of FIG. 7.

FIG. 9 illustrates a close-up, left side perspective view of the cooling device of FIGS. 7 and 8.

FIG. 10 illustrates a rear perspective view of the embodiments of the embodiments of FIGS. 7-9.

FIG. 11 illustrates a front perspective view of an embodiment of the cooling device.

FIG. 12 illustrates another front perspective view of the embodiment of FIG. 11.

FIG. 13 schematically illustrates a top plan view of the interior of the housing of the cooling device.

FIG. 14 illustrates a plan view of the interior of the housing of an embodiment of the cooling device.

Corresponding reference characters indicate corresponding parts throughout several views. The examples set out herein illustrate several embodiments, but should not be construed as limiting in scope in any manner.

### DETAILED DESCRIPTION

It will be further understood that the herein described versions are examples that embody certain inventive concepts as detailed herein. To that end, other variations and modifications will be readily apparent to those of sufficient skill. In addition, certain terms are used throughout this discussion in order to provide a suitable frame of reference with regard to the accompanying drawings. These terms such as “upper”, “lower”, “forward”, “rearward”, “interior”, “exterior” “front”, “back”, “top”, “bottom”, “inner”, “outer”, “first”, “second”, and the like are not intended to limit these concepts, except where so specifically indicated. The terms “about” or “approximately” as used herein may refer to a range of 80%-125% of the claimed or disclosed value. With regard to the drawings, their purpose is to depict salient features of the cooling device and are not specifically provided to scale.

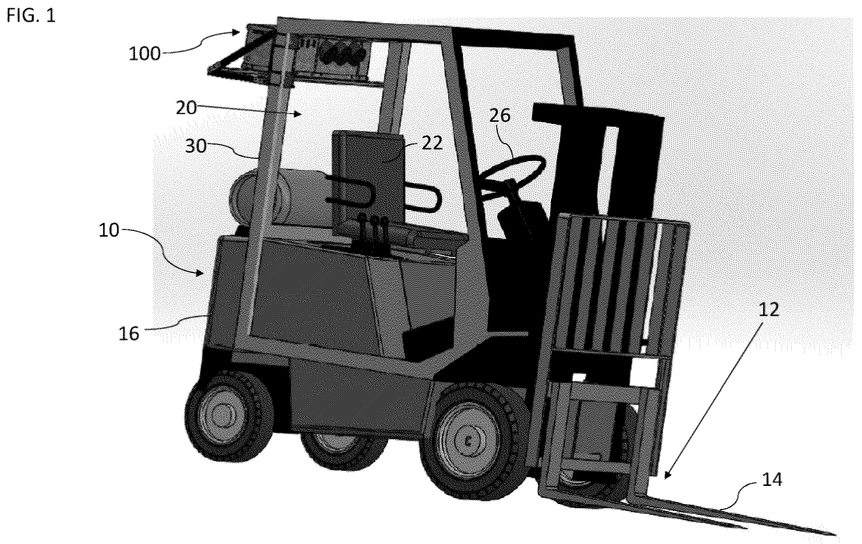

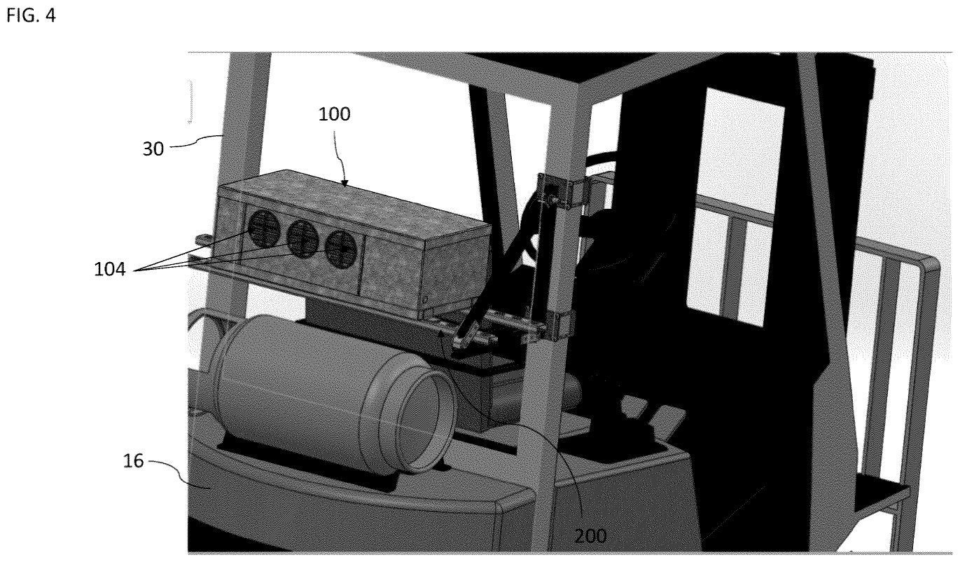

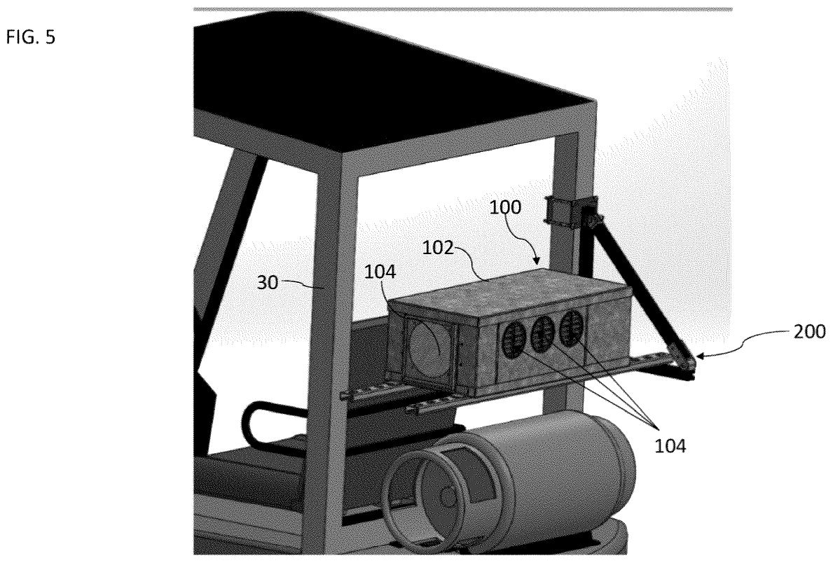

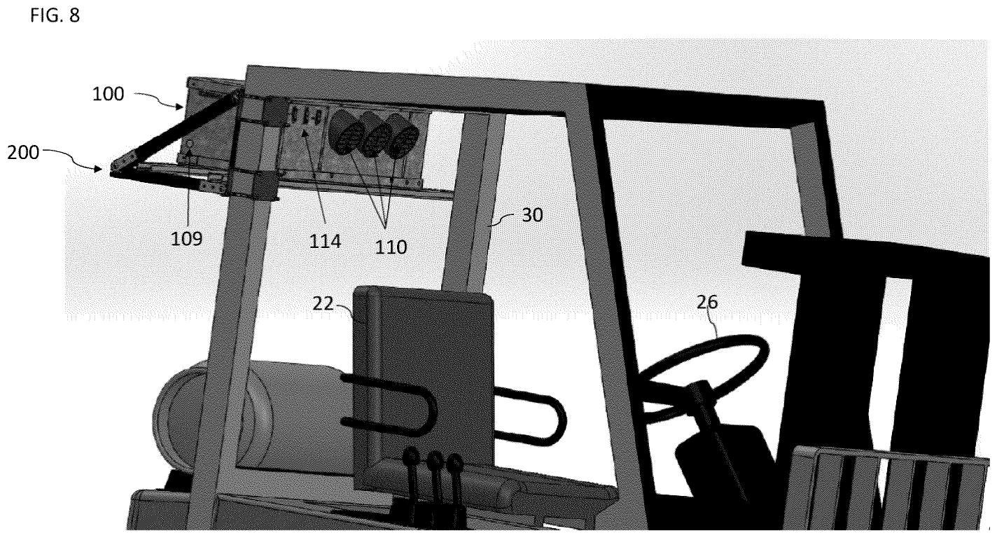

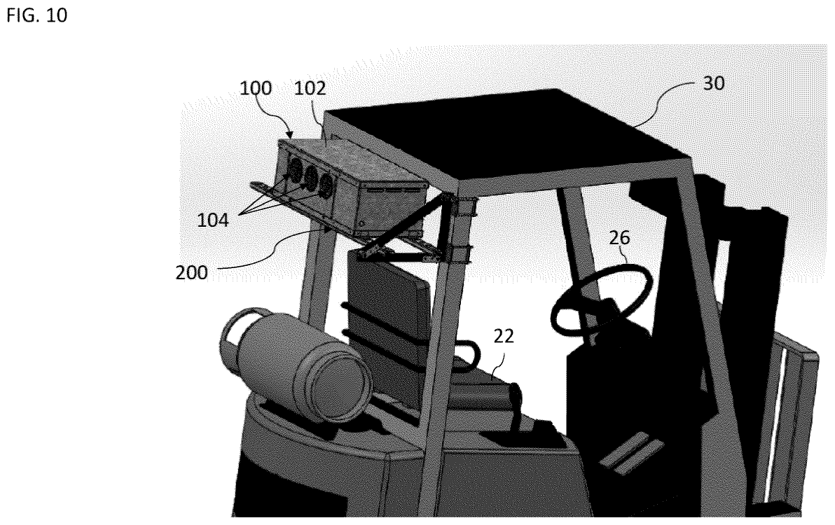

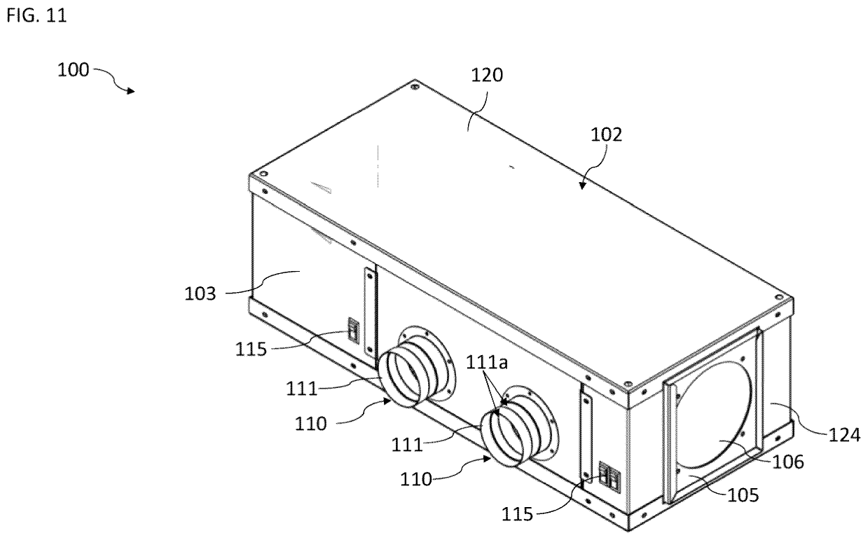

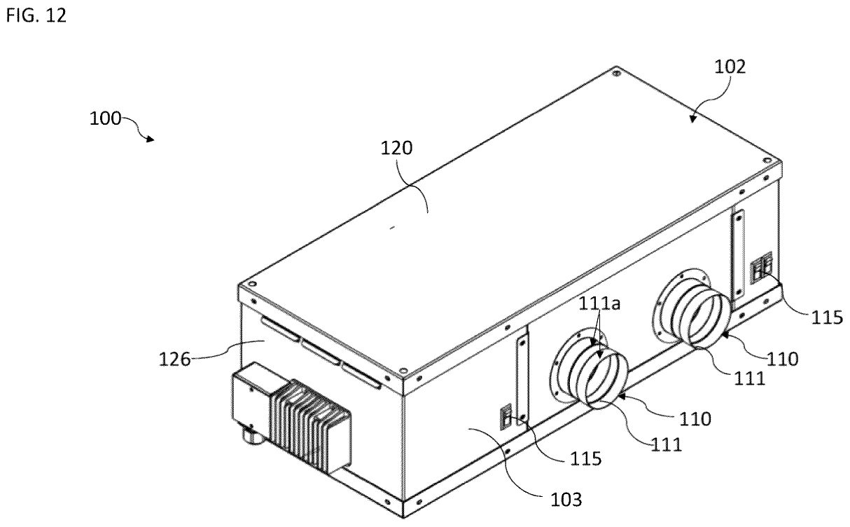

FIGS. 1-12 illustrate an embodiment of a personal, self-contained cooling device (cooling device) 100 being mounted or used with a specific open air vehicle 10 and will be described with reference to such open air vehicle 10. There are several advantages to the cooling device 100 as will be further discussed including its self-contained and compact configuration, low power draw, and its delivery of cooled air in a manner that does not obstruct the operator's view or blow air into the operator's face/eyes. It should be realized that the cooling device 100 can be used with other open air vehicles, such as golf carts, delivery trucks, and various types of heavy machinery. Many of the aspects disclosed herein may apply to the use of the cooling device 100 with these other open air vehicles.

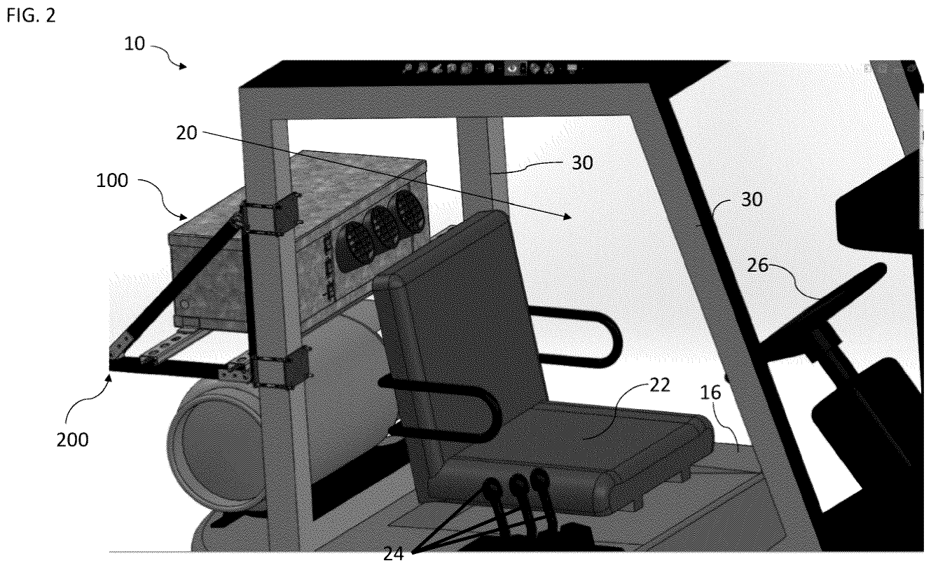

Referring generally to FIGS. 1 and 2, the open air vehicle 10 discussed for reference is a fork lift that includes a loading end 12, which may comprise a fork 14 or other load handling device, and a driver area or an operator area 20. The operator area 20 may include a seat 22 and one or more controls 24 to operate various functions of the open air vehicle 10 including a steering wheel 26. A frame 30 or cage may at least partially surround the operator area 20 and defines one or more openings to the outside environment. As shown, the frame 30 is seated on or coupled to a body 16 of the open air vehicle 10.

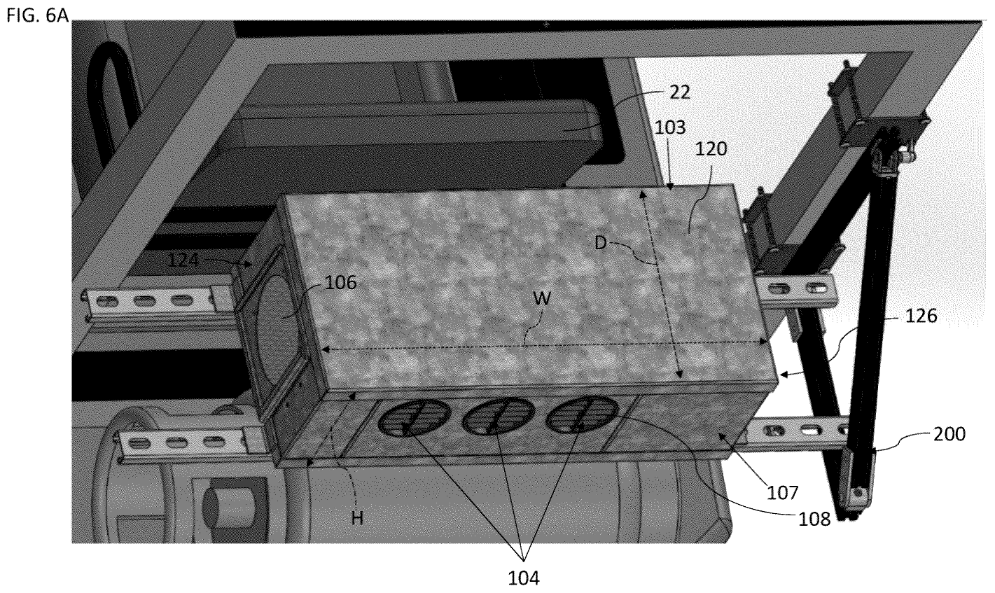

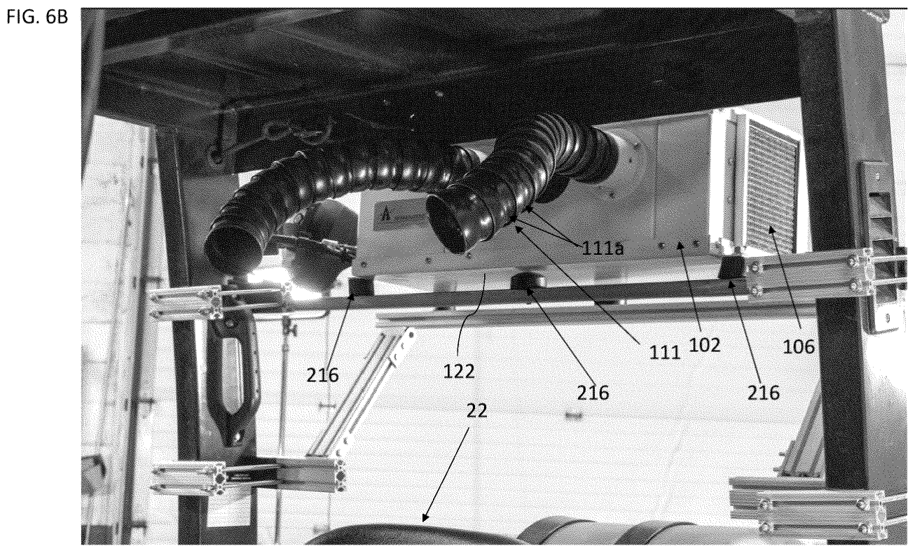

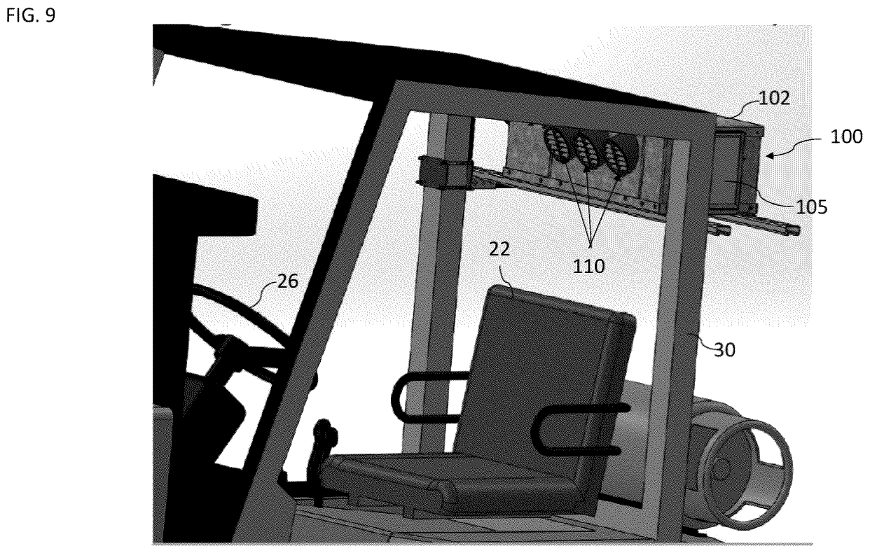

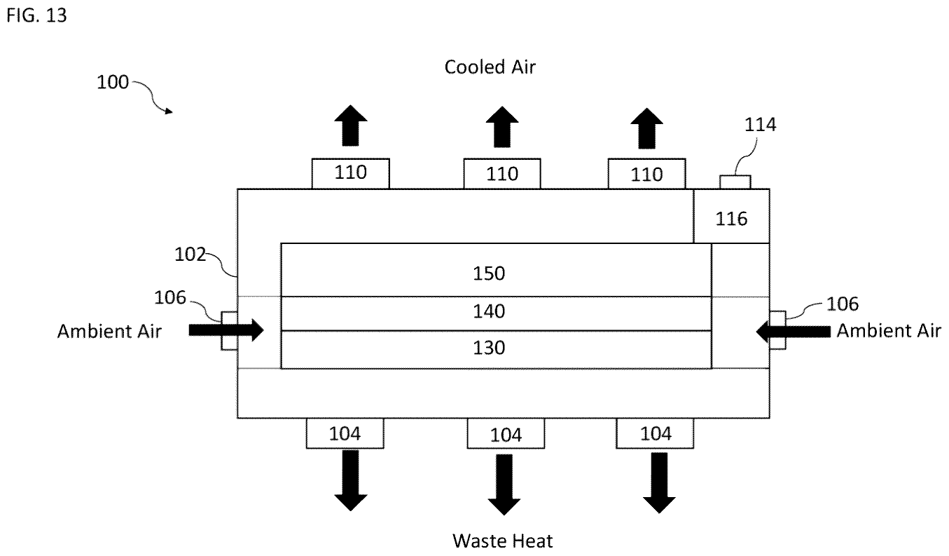

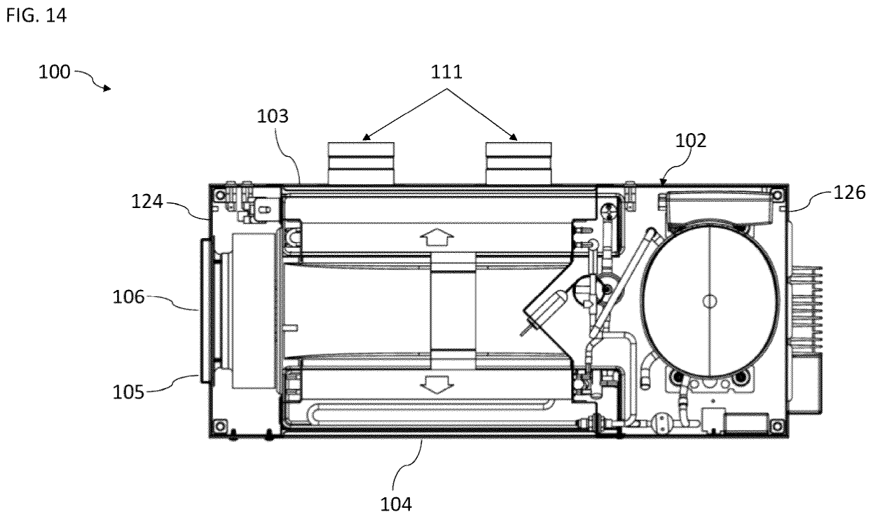

FIGS. 1-12 show an embodiment of the cooling device 100 including a housing 102 that is dimensioned to contain various components of the cooling device 100 such as a control unit 116 (FIGS. 13 and 14) including one or more processors, a compressor (not shown), one or more fans or blowers 130 (FIGS. 13 and 14), a condenser (FIGS. 13 and 14) and an evaporator 140 (FIGS. 13 and 14). FIGS. 1-10 show an embodiment of the cooling device 100 mounted to the frame 30 of the open air vehicle 10 and behind the seat 22 of the operator area 20. The housing 102 defines a plurality of openings on one or more sides. One of these openings is fitted with door 105 (FIG. 9) to enable access to the interior components of the portable cooling device 102. In an embodiment, the top surface 120 of the housing 102 is able to be removed or opened to further provide access to the housing interior. Another opening 109 is structured as a drain to remove any condensation that accumulates inside the housing 102. Additional openings in the side or sides of the housing 102 include one or more air intakes 106 which may be fitted with coverings having rain louvers 108. The air 106 intakes are structured to enable ambient air to be imported or drawn into the cooling device 100. The rain louvers 108 act to inhibit rain water or other moisture from dripping into the intakes 106. Heat vents 104 are also provided in the rear side or rear surface 107 of the housing 102 and expel heat generated by the cooling device 100 away from the operator and into the surrounding environment. In order to fit behind an operator and within the footprint of the open air vehicle, the cooling device 100 must be compact to be properly positioned. In an embodiment, the housing 102 is less than about 30 inches wide (W), less than about 9 inches high (H) and less than about 12 inches deep (D). As show in FIG. 6A, the depth (D) extends from the front side 103 to the rear side 107 of the housing 102, the height (H) extends from the top surface 120 to the bottom surface 122 (FIG. 6B), and the width (W) extends from a right side 124 to a left side surfaces 126 of the housing 102.

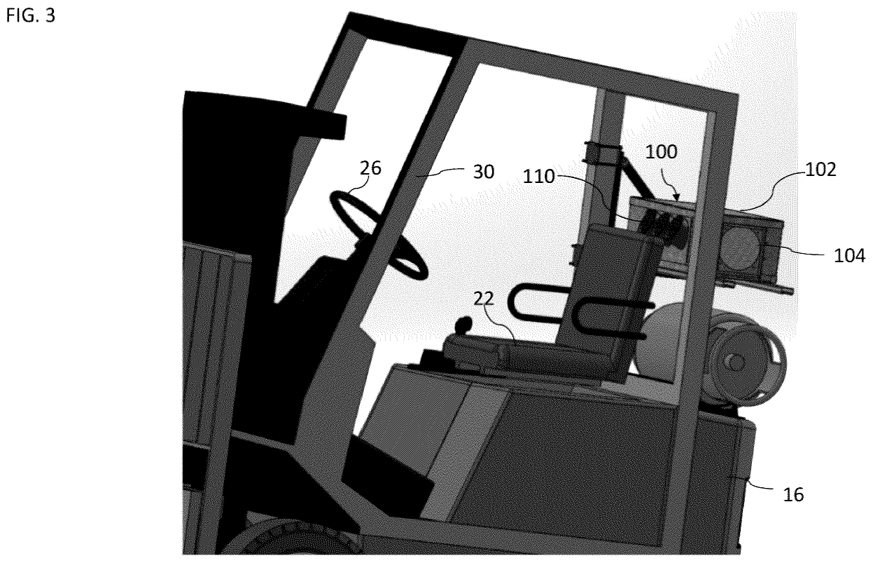

As shown in FIGS. 3, 7-9, 11, and 12, the front side 103 of the housing 102 further includes a plurality of vents 110 that expel cooled air. In an embodiment, each vent is positioned at an angle relative to the front side 103 of the housing 102. As shown, each of the vents 110 may include a plurality of louvers which, along with the angled nature of the vents 110, acts to direct cool air produced by the cooling device 100 to operator while they are seated in the seat 22. The vents 110 act to deliver cool air to targeted areas of the neck and head, which are areas of the body with high concentrations of blood vessels close to the skin surface. Cooling these target areas act to quickly and efficiently provide an overall cooling effect to the operator without obstructing the operator's field of vision or blowing air into the operator's face. Accordingly, the plurality of vents are positioned close to the head/neck area of the operator to deliver cool air to these areas. In an embodiment, one or more flexible/extendable vent extensions or diverters 111 (FIG. 6B) may be coupled to the vents 110 in order to convey cooled air proximate to the back and/or side of the head/neck area of the operator. As shown, the diverters 111 may be formed from a plurality of diverter sections 111a that are moveable coupled to each other. In an embodiment, the plurality of diverter sections 111a are formed as a single unitary component. Since the cooling device 100 is structured to be used in open air vehicles, it is important to make the distance between the point where the cooled air is expelled from the diverters and the target areas of the operator as small as possible. In an embodiment, the diverters may convey cooled air to an area proximate to the head/neck area of the operator not more than about 24 inches from the head and/or neck area of the operator and preferably not more than about 12 inches. In the embodiment shown in FIG. 6B, the diverters 111 may extend partially around a head of the operator such that the operator's head is positioned between the diverters 111. In order to fit behind the operator and within the confines of the open air vehicle 10 without modifying the open air vehicle 10, the cooling device 100 must be compact. In an embodiment, the housing 102 is less than about 30 inches long, less than about 9 inches high and less than about 12 inches deep.

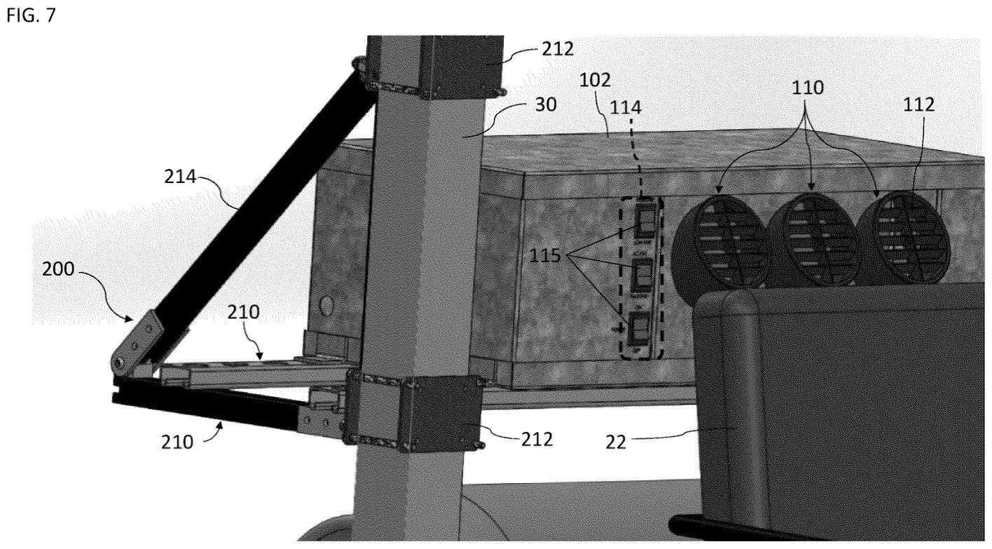

Referring specifically to FIG. 7, a controller 114 is part of the cooling device 100 and may be positioned on the housing 102 of the cooling device 100. The controller 114 is in electrical communication with one or more other components of the cooling device 100, such as the control unit 116 (FIGS. 13 and 14) and/or the blowers/fans 130 (FIGS. 13 and 14). Accordingly, the controller 114 enables the operator to control various aspects of the cooling device 100 such as turning the cooling device 100 on/off, adjusting the temperature of the cooled air produced by the cooling device 100 and adjusting the speed of the air exiting the vents 110. As shown, the controller 114 includes a plurality of inputs 115, such as switches, however other embodiments of the controller 114 may include an input interface, such as a touch screen. In still another embodiment, the controller 114 may be positioned in the driver area 20 and spaced apart from the housing 102, but in communication with the control unit 116.

The cooling device 100 may be structured to electrically couple to an onboard power supply of the open air vehicle, such as a battery. The cooling device 100 is a low power draw (does not require more than about 600 W) device so it will not impede performance of the vehicle by quickly depleting the battery. In some embodiments, one or more of the cooling vents or vents 110 (including the diverters 111) are configured to automatically adjust according to changes in the operator's (and/or passenger) position. In this way, the one or more of the vents 110 track movement of the operator's (and/or passenger) head/neck so that this area is cooled continuously without the need to keep repositioning the vent(s) 110 to accommodate the different positions in which the operator (and/or passenger) finds themself.

Comparing FIGS. 2-7 with FIGS. 1 and 8-10, it is shown that the position of the cooling device 100 can be vertically adjusted relative to the frame 30 and the seat 22 in order to accommodate operators of different heights and/or based on each operator's preferences. The vertical adjustment may be accomplished manually or automatically. In the case of manual adjustment, one or more brackets are operative to couple the cooling device 100 to a portion of the open air vehicle, such as the frame 30. The one or more brackets may be moveably coupled to the frame 30 and structured to be unlocked to enable adjustment, and respectively locked to inhibit adjustment.

In an embodiment, the cooling device 100 is mounted to the open air vehicle 10 using a mounting assembly 200. Referring to FIG. 7, one embodiment of the mounting assembly 200 includes a mounting frame or platform 210 that is coupled to the open air vehicle 10 using one or more coupling elements 212 such as clamps or brackets. The mounting assembly 200 may further include one or more support members 214 attached to the mounting frame 210 and/or coupling elements 212. As shown, the cooling device 100 is seated or otherwise secured or attached to the mounting frame 210 and the one or more coupling elements 212 attach the mounting frame 210 to the open air vehicle 10. The one or more support members 214 may be added for extra strength, rigidity and/or better attachment to the open air vehicle 10. As previously mentioned, the mounting assembly 200 may be adjustable such that the position of the cooling device 100 relative to the operator can be changed to accommodate the preferences of different operators. In a further embodiment, the mounting assembly 200 may further comprise one or more vibration dampening elements 216 (FIG. 613) to eliminate or lessen the vibrations imparted to the open-air vehicle 10 by the housing 102 or the cooling device 100. In an embodiment, one or more of the mounting assembly 200 components may be comprised of a metal, a metal alloy, a plastic or other suitable durable material. In some embodiments, the mounting assembly 200 further comprises one or more cables structured to support at least a portion of the housing 102 and/or structured to operatively couple the housing to the open air vehicle.

In other embodiments, the cooling device 100 may be attached to the open air vehicle 10 via the one or more support members 214. In such an embodiment, the one or more support members 214 may slidably or removably engage the housing 102 and/or the cooling device 100. The one or more support members 214 may further include or be attached to a coupling element 212 to adjustably couple the one or more support members 214 to the open air vehicle 10. In an embodiment, an actuator may be operatively coupled to one or more components of the mounting assembly 200. In the case of automatic adjustment, a track may be provided that is coupled to the frame 30 such that the cooling device 100 via a part of the mounting assembly 200 is moved relative to the open air vehicle 10 along the track using an actuator.

When one or more of the vents 110 is structured to automatically track the position of the operator and/or passenger, adjustment of the cooling device 100 itself may not be necessary. As previously noted, the cooling device 100 is positioned behind the operator (and passenger) such that it does not obstruct the operator's field of view. As can be seen in the figures, the cooling device 100 is dimensioned to fit within the footprint of the body 16 of the open air vehicle 10 and specifically behind the operator. In this manner, the cooling device 100 does not increase the maximum length, width or height dimensions of the open air vehicle 10, which could result in the open air vehicle being too large in one or more dimensions to be used for their intended tasks. In an embodiment, the cooling device 100 and the mounting assembly 200 comprise a kit to retrofit an open air vehicle 10. As shown, the cooling device 100 is portable and may be uninstalled from one open air vehicle and installed into a different open air vehicle easily and quickly. When the cooling device 100 is installed in a delivery truck, it is dimensioned to be mounted directly behind the operator without any modifications to the inside of the delivery truck.

FIG. 13 schematically illustrates an embodiment of the interior components of the cooling device 100 and FIG. 14 illustrates a plan view of an embodiment of the interior of the cooling device 100. Ambient air is imported from the environment via the one or more intake openings or intakes 106. One or more fans 130 move the air to the evaporator 140 and condenser 150 sections where said air is cooled. The cooled air is then ejected through the one or more vents 110 and directed at the back of the operator's head/neck. The cool air ejected through the one or more vents 110 is at least 10 degrees cooler than the ambient temperature. In the embodiment shown, condenser air exits the housing 102 through the one or more exhaust vents or heat vents 104 positioned on the rear surface 107 of the housing, which prevents short cycling with intake air. In an embodiment, the condensate will be evaporated using a hot gas refrigeration loop and condenser air stream. The housing 102 is structured to accept at least one air filter to inhibit the condenser and/or evaporator from being coated or clogged with dust and dirt.

One or more components of the cooling device 100 are comprised of a metal/metal alloy, such as aluminum and/or galvanized steel. Certain components such as the vents and the rain louvers may be comprised of the metal or may be comprised of a rigid, temperature resistant plastic.

It should be understood that various changes and modifications to the embodiments described herein will be apparent to those skilled in the art. Such changes and modifications can be made without departing from the spirit and scope of the present disclosure and without diminishing its intended advantages.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure.

1. A portable cooling device for an open air vehicle, comprising:
a housing structured to be installed behind an operator of the open air vehicle, the housing including a front surface, an opposing rear surface and right and left side surfaces;
one or more intakes positioned on at least of the side surfaces of the housing and structured to enable intake of ambient air surrounding an outside of the housing;
one or more exhaust vents positioned on the rear surface of the housing and structured to enable heat from inside the housing to dissipate to an outside of the housing;
one or more cooling vents positioned on the front surface of the housing;
a condenser positioned within the housing;
an evaporator positioned within the housing;
one or more fans positioned in the housing and structured to,
draw ambient air through the one or more intakes,
move the ambient air though the evaporator and condenser, and
expel cooled air from the one or more cooling vents; and
one or more diverters coupled to each of the one or more cooling vents and structured to convey the cooled air from the one or more cooling vents to an area proximate to a head or neck of the operator of the open air vehicle,
wherein a housing width is defined as a dimension from the right side to the left side,
wherein a housing depth is defined as a dimension from the front surface to the opposing rear surface,
wherein the width is less than about 30 inches and the depth is less than about 12 inches.

2. The portable cooling device of claim 1, wherein the housing further includes a top surface and a bottom surface, wherein a height is defined as a dimension from the top surface to the bottom surface, and wherein the height is less than about 9 inches.

3. The portable cooling device of claim 2, wherein the area proximate to the head or neck of the operator is about 12 inches from the head or neck of the operator.

4. The portable cooling device of claim 3, further structured to cool the ambient air drawn in by the one or more intakes to a temperature at least 10° cooler than the ambient air.

5. The portable cooling device of claim 1, wherein the one or more diverters are flexible and positioned to be on either side of the operator when installed in the open air vehicle.

6. The portable cooling device of claim 1, wherein the one or more diverters are structured to automatically adjust according to changes in operator's body position.

7. The portable cooling device of claim 1, wherein the portable cooling device requires not more than about 600 W of power to operate.

8. A portable cooling system for an open air vehicle, comprising:
a portable cooling device comprising,
a housing structured to be installed behind an operator of the open air vehicle, the housing including a front surface, an opposing rear surface and right and left side surfaces,
one or more intakes positioned on at least of the side surfaces of the housing and structured to enable intake of ambient air surrounding an outside of the housing,
one or more exhaust vents positioned on the rear surface of the housing and structured to enable heat from inside the housing to dissipate to an outside of the housing,
one or more cooling vents positioned on the front surface of the housing,
a condenser positioned within the housing,
an evaporator positioned within the housing,
one or more fans positioned in the housing and structured to,
draw ambient air through the one or more intakes,
move the ambient air though the evaporator and condenser, and
expel cooled air from the one or more cooling vents, and
one or more diverters coupled to each of the one or more cooling vents and structured to convey the cooled air from the one or more cooling vents to an area proximate to a head or neck of the operator of the open air vehicle; and
a mounting assembly structured to mount to the open air vehicle in a location behind the operator, the mounting assembly including,
one or more clamps or brackets structured to engage a frame of an open air vehicle,
a mounting frame structured to support the housing, and
one or more vibration damping elements coupled to the mounting frame and structured to lessen vibrations imparted to the open air vehicle by the housing.

9. The portable cooling system of claim 8, wherein the mounting assembly further includes an actuator structured to move one or more components of the mounting assembly relative to the frame of the open air vehicle.

10. The portable cooling system of claim 8, wherein a housing width is defined as a dimension from the right side to the left side, wherein a housing depth is defined as a dimension from the front surface to the opposing rear surface, and wherein the width is less than about 30 inches and the depth is less than about 12 inches.

11. The portable cooling device of claim 8, wherein the housing further includes a top surface and a bottom surface, wherein a height is defined as a dimension from the top surface to the bottom surface, and wherein the height is less than about 9 inches.

12. The portable cooling device of claim 9, wherein the area proximate to the head or neck of the operator is about 12 inches from the head or neck of the operator.

13. The portable cooling device of claim 12, further structured to cool the ambient air drawn in by the one or more intakes to a temperature at least 10° cooler than the ambient air.

14. The portable cooling device of claim 8, wherein the one or more diverters are flexible and positioned to be on either side of the operator when installed in the open air vehicle.

15. The portable cooling device of claim 8, wherein the one or more diverters are structured to automatically adjust according to changes in operator's body position.

16. The portable cooling device of claim 8, wherein the portable cooling device requires not more than about 600 W of power to operate.
